(19) United States
(12) Patent Application Publication
(10) Pub. No.: US 2026/0177863 A1
(43) Pub. Date: Jun. 25, 2026

(54) DISPLAY APPARATUS

(71) Applicant: SAMSUNG ELECTRONICS CO., LTD., Suwon-si (KR)

(72) Inventors: Ajeong KANG, Suwon-si (KR); Dukjin JEON, Suwon-si (KR); Youngmin LEE, Suwon-si (KR); Sunghee WI, Suwon-si (KR); Seungyong SHIN, Suwon-si (KR); Sungyeol KIM, Suwon-si (KR)

(73) Assignee: SAMSUNG ELECTRONICS CO., LTD., Suwon-si (KR)

(21) Appl. No.: 19/417,673

(22) Filed: Dec. 12, 2025

Related U.S. Application Data
(63) Continuation of application No. PCT/KR2025/016873, filed on Oct. 23, 2025.

(30) Foreign Application Priority Data
Dec. 23, 2024 (KR) 10-2024-0194012
Apr. 7, 2025 (KR) 10-2025-0045002

(51) Int. Cl. G02F 1/1335; G02F 1/13357

(52) U.S. Cl. CPC G02F 1/133613; G02F 1/133601; G02F 1/133603; G02F 1/133611; G02F 1/133612

(57) ABSTRACT

A display apparatus includes: a display panel; a light guide plate at a rear of the display panel; a light source board; a plurality of light sources on the light source board and adjacent to a peripheral surface of the light guide plate, the plurality of light sources being configured to emit light toward the peripheral surface of the light guide plate; a plurality of ribs between the light guide plate and the light source board and between light sources among, the plurality of ribs being between the plurality of light sources; and a control board connected to the light source board and configured to supply a driving current to the plurality of light sources, where the plurality of light sources includes a first number of first light sources, and a second number of second light sources.

### CROSS-REFERENCE TO RELATED APPLICATION(S)

This application is a continuation of International Application No. PCT/KR2025/016873, filed on Oct. 23, 2025, in the Korean Intellectual Property Receiving Office, which is based on and claims priority to Korean Patent Application No. 10-2024-0194012, filed on Dec. 23, 2024 and Korean Patent Application No. 10-2025-0045002, filed on Apr. 7, 2025, in the Korean Intellectual Property Office, the disclosures of which are incorporated by reference herein in their entireties.

### BACKGROUND

### 1. Field

The present disclosure relates to a display apparatus.

### 2. Description of Related Art

A display apparatus is a type of an output apparatus that may convert obtained or stored electrical information into visual information and display the visual information to a user. The display apparatus may be used in various fields, such as a home, a workplace, etc.

A display apparatus may include a monitor apparatus connected to a personal computer or a server computer, a portable computer device, a navigation terminal device, a general television apparatus, an Internet Protocol television (IPTV), a portable terminal device, such as a smart phone, a tablet PC, a personal digital assistant (PDA) or a cellular phone, various display apparatuses used to reproduce images, such as advertisements or movies in an industrial field, or various kinds of audio/video systems.

A display apparatus may include a self-emitting display panel or a passive light-emitting display panel.

A display apparatus to which a passive light-emitting display panel is applied may include a liquid-crystal panel and a backlight unit that supplies light to the liquid crystal panel.

The backlight unit may include a light source module composed of a light source and a circuit board, and various optical members, and may be classified into a direct type backlight unit and an edge type backlight unit according to the position of the light source. An edge-type backlight unit may be equipped with a light guide plate (LGP) to guide light emitted from the light source to the liquid crystal panel.

### SUMMARY

Provided is a display apparatus which may have an improved structure to reduce and/or prevent visibility of dark areas on a screen even when an area with limited light quantity occurs due to a structure of a backlight unit.

Further, provided is a display apparatus which may have improved uniformity of luminance on a screen.

Additional aspects will be set forth in part in the description which follows and, in part, will be apparent from the description, or may be learned by practice of the presented embodiments.

A display apparatus according to an embodiment of the present disclosure may include: a display panel; a light guide plate at a rear of the display panel; a light source board; a plurality of light sources on the light source board and adjacent to a peripheral surface of the light guide plate, the plurality of light sources being configured to emit light toward the peripheral surface of the light guide plate; a plurality of ribs between the light guide plate and the light source board and between light sources among the plurality of light sources, the plurality of ribs being between the plurality of light sources; and a control board connected to the light source board and configured to supply a driving current to the plurality of light sources. The plurality of light sources may include a first number of first light sources, and a second number of second light sources, the second number being greater than the first number. The first light sources may be between a first rib and a second rib that is adjacent to the first rib among the plurality of ribs. The second light sources may be between the second rib and a third rib that is adjacent to the second rib among the plurality of ribs. The control board may be configured to: supply a first current of a first magnitude to at least some of the first light sources, and supply a second current of a second magnitude smaller than the first magnitude to at least some of the second light sources.

The control board may be further configured to supply the first current to a light source, among the first light sources, closest to the second rib.

The control board may be further configured to supply the second current to a light source, among the second light sources, closest to the second rib.

The display apparatus may further include a plurality of dimming blocks, each of the plurality of dimming blocks including a predetermined number of light sources among the plurality of light sources. All light sources comprised in one or more dimming blocks among the plurality of dimming blocks may be the first light sources. The control board may be further configured to supply the first current to each light source included in the one or more dimming blocks.

The display apparatus may further include a plurality of dimming blocks, each of the plurality of dimming blocks including a predetermined number of light sources among the plurality of light sources. Among the plurality of dimming blocks, a first dimming block may include a light source that is closest to the second rib among the first light sources. The control board may be further configured to supply the first current to each light source included in the first dimming block.

The first dimming block may further include one or more light sources, among the second light sources, adjacent to the second rib.

The display apparatus may further include a plurality of dimming blocks, each of the plurality of dimming blocks including a predetermined number of light sources among the plurality of light sources. All light sources comprised in one or more dimming blocks among the plurality of dimming blocks may be the second light sources. The control board may be further configured to supply the second current to each light source included in the one or more dimming blocks.

The display apparatus may further include a plurality of dimming blocks, each of the plurality of dimming blocks including a predetermined number of light sources among the plurality of light sources. Among the plurality of dimming blocks, a first dimming block may include a light source that is closest to the second rib among the second light sources. The control board may be further configured to supply the second current to each light source included in the first dimming block.

The first dimming block may further include one or more light sources, among the first light sources, adjacent to the second rib.

The first light sources may be arranged to be spaced apart from each other by a first interval, where the second light sources are arranged to be spaced apart from each other by the first interval, and where one of the first light sources that is closest to the second rib and one of the second light sources that is closest to the second rib are spaced apart from each other by a second interval that is larger than the first interval.

The plurality of light sources may further include a third number of third light sources, the third number being greater than the first number and less than the second number. The third light sources may be between the third rib and a fourth rib that is adjacent to the third rib among the plurality of ribs. The control board may be further configured to supply the second current to at least some of the third light sources.

The plurality of light sources may further include a third number of third light sources, the third number being greater than the second number. The third light sources may be between the third rib and a fourth rib that is adjacent to the third rib among the plurality of ribs. The control board may be further configured to supply a third current of a third magnitude less than the second magnitude to at least some of the third light sources.

The first current may be a maximum current supplied to the at least some of the first light sources. The second current may be a maximum current supplied to the at least some of the second light sources.

The second rib may be between the first rib and the third rib. The first rib, the second rib, and the third rib may be sequentially arranged along a direction in which the plurality of light sources are arranged.

The display panel may include a first area corresponding to the first light sources, and a second area corresponding to the second light sources. A difference between the first magnitude of the first current and the second magnitude of the second current may be based on a difference between a luminance of light emitted from the first area and a luminance of light emitted from the second area.

A display apparatus according to an embodiment of the present disclosure may include: a display panel; a light guide plate at a rear of the display panel; a light source board; a plurality of light sources on the light source board and adjacent to a peripheral surface of the light guide plate, the plurality of light sources being configured to emit light toward the peripheral surface of the light guide plate; a plurality of ribs between the light guide plate and the light source board and between the plurality of light sources; a plurality of dimming blocks, each of the plurality of dimming blocks including light sources of the plurality of light sources; and a control board connected to the light source board and configured to supply a driving current to the plurality of light sources. The plurality of light sources may include: a first number of first light sources; and a second number of second light sources, the second number being greater than the first number. The plurality of dimming blocks may include a first dimming block including at least some of the first light sources, and a second dimming block including at least some of the second light sources. The first light sources may be between a first rib and a second rib that is adjacent to the first rib among the plurality of ribs. The second light sources may be between the second rib and a third rib that is adjacent to the second rib among the plurality of ribs. The control board may be configured to: supply a first current of a first magnitude to the first dimming block, and supply a second current of a second magnitude less than the first magnitude to the second dimming block.

All light sources comprised in the first dimming block among the plurality of dimming blocks may be the first light sources.

The first dimming block may further include one or more light sources, among the second light sources, adjacent to the second rib.

All light sources comprised in the second dimming block among the plurality of dimming blocks may be the second light sources.

The second dimming block may further include one or more light sources, among the first light sources, adjacent to the second rib.

A display apparatus according to an embodiment of the present disclosure may include a display panel, a light guide plate disposed at a rear of the display panel, a plurality of light sources disposed adjacent to a peripheral surface of the light guide plate and configured to emit light toward the peripheral surface of the light guide plate, and a control board configured to supply a driving current to the plurality of light sources. The plurality of light sources may include a first light source group including a first number of first light sources arranged spaced apart from each other by a first interval, and a second light source group including a second number of second light sources, which is greater than the first number, arranged spaced apart from each other by the first interval, the second light source group being spaced apart from the first light source group by a second interval greater than the first interval. The control board may be configured to supply a first magnitude of current to at least some of the first light sources included in the first light source group, and supply a second magnitude of current, which is smaller than the first magnitude, to at least some of the second light sources included in the second light source group.

A display apparatus according to an embodiment of the present disclosure may include a display panel, a light guide plate disposed at a rear of the display panel, a plurality of light sources disposed adjacent to a peripheral surface of the light guide plate and configured to emit light toward the peripheral surface of the light guide plate, a first light source board on which a first number of light sources among the plurality of light sources are mounted, a second light source board adjacent to the first light source board, on which a second number of light sources, which is greater than the first number, among the plurality of light sources are mounted, and a control board connected to the first light source board and the second light source board and configured to supply a driving current to the plurality of light sources. The control board may be configured to supply a first magnitude of current to at least some of the light sources mounted on the first light source board, and supply a second magnitude of current to at least some of the light sources mounted on the second light source board.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a perspective view of a display apparatus according to an embodiment of the present disclosure;

FIG. 2 is an exploded perspective view of a display apparatus according to an embodiment of the present disclosure;

FIG. 3 is a cross-sectional view illustrating some components of a display apparatus according to an embodiment of the present disclosure;

FIG. 4 is a cross-sectional view illustrating some components of a display apparatus according to an embodiment of the present disclosure;

FIG. 5 is an enlarged view illustrating a part of a light source module of a display apparatus according to an embodiment of the present disclosure;

FIG. 6 is an enlarged view illustrating a light source module of a display apparatus, and parts of a screen and ribs corresponding thereto according to an embodiment of the present disclosure;

FIG. 7 is a diagram illustrating some light source groups and dimming blocks included in a light source module of a display apparatus according to an embodiment of the present disclosure;

FIG. 8 is a diagram illustrating some light source groups and dimming blocks included in a light source module of a display apparatus according to an embodiment of the present disclosure;

FIG. 9 is a diagram illustrating some light source groups and dimming blocks included in a light source module of a display apparatus according to an embodiment of the present disclosure;

FIG. 10 is an enlarged view illustrating a part of a light source module of a display apparatus according to an embodiment of the present disclosure;

FIG. 11 is an enlarged view illustrating a light source module of a display apparatus, and parts of a screen corresponding thereto according to an embodiment of the present disclosure;

FIG. 12 is a diagram illustrating areas on a screen of a display apparatus and maximum current supplied to corresponding light sources according to an embodiment of the present disclosure; and

FIG. 13 is a diagram illustrating areas on a screen of a display apparatus and maximum current supplied to corresponding light sources according to an embodiment of the present disclosure.

### DETAILED DESCRIPTION

The embodiments described in the disclosure and the configurations shown in the drawings are only examples of the disclosure, and various modifications may be made to the embodiments and drawings of the disclosure described herein.

In the description of the drawings, like numbers refer to like elements throughout the description of the drawings.

The terms used herein are for the purpose of describing the embodiments and are not intended to restrict and/or to limit the disclosure. The singular expressions herein may include plural expressions, unless the context clearly dictates otherwise. In addition, the terms “comprises”, “includes”, “has”, and variations thereof, are intended to indicate the presence of features, numbers, steps, operations, elements, parts, or combinations thereof described in the disclosure, and do not exclude the presence or addition of one or more other features, numbers, steps, operations, elements, parts, or combinations thereof.

When any component is referred to as being “connected,” “coupled,” “supported” or “in contact” with another component, this includes a case in which the components are indirectly connected, coupled, supported, or in contact with each other through a third component as well as directly connected, coupled, supported, or in contact with each other.

It will also be understood that when one component is referred to as being “on” or “over” another component, it may be directly on the other component or intervening components may also be present.

It will be understood that, although the terms first, second, and the like, used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

Hereinafter, various embodiments of the present disclosure will be described in detail with reference to the accompanying drawings.

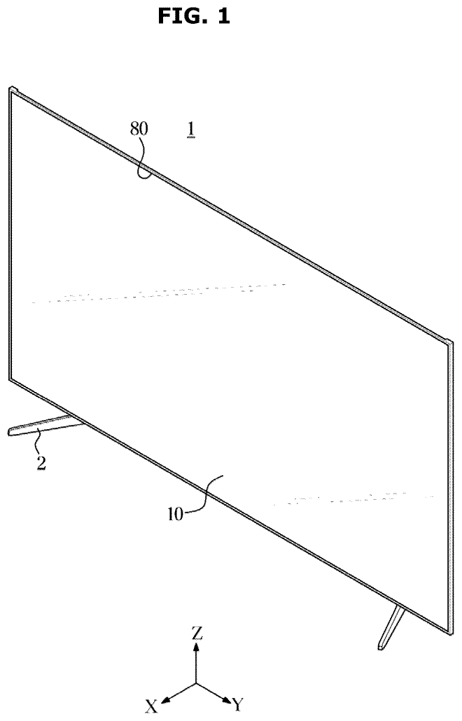

In describing various embodiments of the present disclosure with reference to FIGS. 1 to 13, the terms “front-rear direction,” “vertical direction (up-down direction),” and “horizontal direction (left-right direction),” as used in the following description, are defined with reference to the drawings, and the shapes and positions of the respective components are not limited by these terms. For example, the term “front-rear direction” may refer to a direction parallel to the X-axis in the drawings, “front” may refer to a direction in which an image is provided through a screen, and “rear” may refer to a direction opposite to the “front.” For example, the term “vertical direction (up-down direction)” may refer to a direction parallel to the Z-axis in the drawings, and “upward” and “downward” may respectively refer to an upward direction along the Z-axis and a downward direction along the Z-axis in the drawings. For example, the term “horizontal direction (left-right direction)” may refer to a direction parallel to the Y-axis in the drawings.

FIG. 1 is a perspective view of a display apparatus according to an embodiment of the present disclosure.

Referring to FIG. 1, a display apparatus 1 according to various embodiments of the present disclosure is an apparatus capable of processing image signals received from the outside and visually displaying the processed images.

For example, the display apparatus 1 according to various embodiments of the present disclosure may be implemented in various forms, such as a television (TV), a monitor, which is a type of output device of a computer, a portable multimedia device, and a portable communication device. For example, the display apparatus 1 according to various embodiments of the present disclosure may be a large format display (LFD) installed outdoors, such as a rooftop or a bus stop. Here, the term “outdoors” is not limited to the open air, but the display apparatus 1 according to various embodiments of the present disclosure may be installed in places that, although indoors, may be accessed by a large number of people, such as subway stations, shopping malls, movie theaters, companies, and stores. The type of display apparatus 1 according to various embodiments of the present disclosure is not limited to the examples described above, as long as it is an apparatus that may visually display images.

In FIG. 1, a flat-panel display apparatus with a flat screen is illustrated as an example of the display apparatus 1, but the disclosure is not limited thereto, and the display apparatus 1 according to various embodiments of the present disclosure may include a curved display apparatus or a bendable or flexible display apparatus in which a flat state and a curved state are variable. The configuration of the present disclosure described below may be applied to display apparatuses of various shapes, regardless of the screen size or aspect ratio.

According to various embodiments, the display apparatus 1 may be installed in a standing manner on the floor or furniture indoors or outdoors. For example, the display apparatus 1 may include a support leg 2 that supports a lower portion of a case of the display apparatus 1 and may be installed in a standing manner on the floor or furniture indoors or outdoors. According to various embodiments, the display apparatus 1 may be installed on or inside a wall of a building or other structure. For example, the display apparatus 1 may be installed on a wall by a wall mount device.

The display apparatus 1 may receive content including video signals and audio signals from various content sources and may output video and audio corresponding to the video signals and the audio signals. For example, the display apparatus 1 may receive content data through a broadcast reception antenna or a wired cable, receive content data from a content playback device, or receive content data from a content providing server of a content provider.

The display apparatus 1 may display an image corresponding to video data and output sound corresponding to audio data. For example, the display apparatus 1 may restore a plurality of image frames included in the video data and sequentially display the plurality of image frames. In addition, the display apparatus 1 may restore audio signals included in the audio data and sequentially output sound according to the audio signals.

The display apparatus 1 may include a display panel 10. The display panel 10 may be configured to output and display an image. The display panel 10 may form a screen on a front surface and may display an image through the screen. For example, the display panel 10 may display a still image or a moving image through the screen. For example, the display panel 10 may display a two-dimensional planar image or a three-dimensional stereoscopic image through the screen to a user.

The display panel 10 may include a plurality of pixels on the screen. The image displayed on the screen may be formed by light emitted by each of the plurality of pixels. For example, the light emitted from the plurality of pixels may be combined like a mosaic, thereby forming an image on the screen.

Each of the plurality of pixels may emit different brightness and different colors of light. Particularly, each of the plurality of pixels may include sub-pixels, and the sub-pixels may include a red sub pixel emitting red light, a green sub pixel emitting green light, and a blue sub pixel emitting blue light. For example, the red light may represent a light beam having a wavelength of approximately 620 nm (nanometers, one billionth of a meter) to 750 nm, the green light may represent a light beam having a wavelength of approximately 495 nm to 570 nm, and the blue light may represent a light beam having a wavelength of approximately 450 nm to 495 nm.

By a combination of the light emitted from the red sub pixel, the green sub pixel, and the blue sub pixel, each of the plurality of pixels may emit different brightness and different color of light.

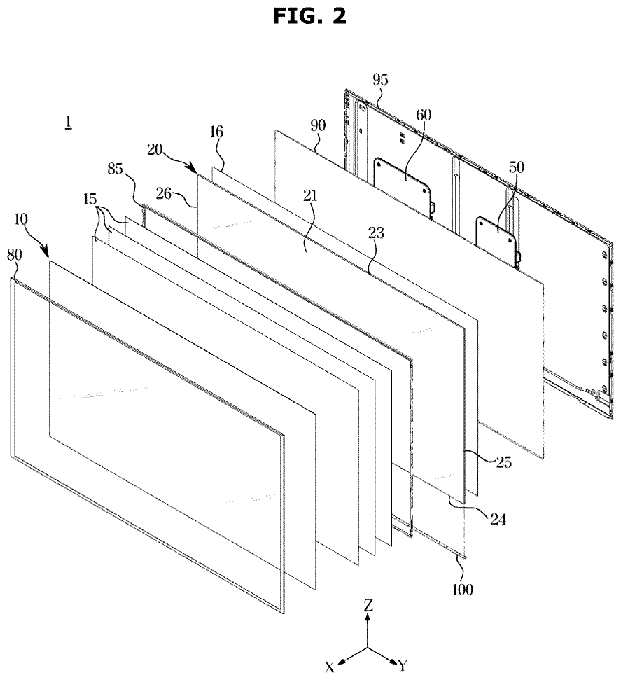

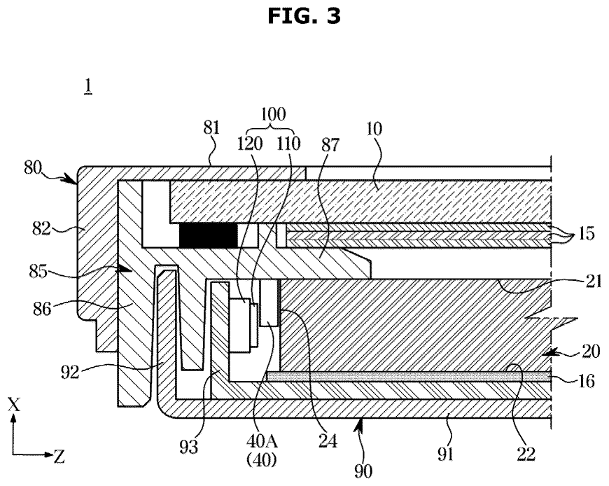

FIG. 2 is an exploded perspective view of a display apparatus according to an embodiment of the present disclosure. FIG. 3 is a cross-sectional view illustrating some components of a display apparatus according to an embodiment of the present disclosure.

Referring to FIGS. 2 and 3, the display apparatus 1 according to an embodiment of the present disclosure may include various components for outputting images through the display panel 10.

In the display apparatus 1 according to an embodiment of the present disclosure, the display panel 10 may be configured as a passive light-emitting display type panel such as a liquid crystal display (LCD).

The display panel 10 of the liquid crystal type display panel may display images using liquid crystals that exhibit optical properties according to changes in voltage and temperature. The display panel 10 may include a thin film transistor (TFT) substrate, a color filter substrate coupled to face the TFT substrate, and liquid crystal molecules injected between the TFT substrate and the color filter substrate.

As an example, the screen of the display panel 10 may have an approximately rectangular shape. As an example, the screen of the display panel 10 may include a pair of long sides extending in the horizontal direction Y and a pair of short sides extending in the vertical direction Z. However, the disclosure is not limited thereto, and the screen of the display panel 10 may have various shapes such as a rectangular shape including a pair of long sides extending in the vertical direction Z and a pair of short sides extending in the horizontal direction Y, or a square shape.

On one side (e.g., a lower side) of the display panel 10, a cable that transmits image data to the display panel 10 and a display driver integrated circuit (DDI), which processes digital image data and outputs an analog image signal (hereinafter referred to as a “driver IC”), may be provided.

The cable may electrically connect a circuit board assembly 50, 60 to the driver IC, and may also electrically connect the driver IC to the display panel 10. The cable may include a flexible flat cable or a film cable that is bendable.

The driver IC may receive the image data and/or power from the circuit board assembly 50, 60 through the cable, and supply the image data and/or a driving current to the display panel 10 through the cable.

For example, the cable and the driver IC may be integrally implemented as a film cable, a chip on film (COF), a tape carrier package (TCP), or the like. For example, the driver IC may be disposed on the cable.

The display apparatus 1 may include a backlight unit configured to emit light toward the display panel 10. The backlight unit may be arranged at the rear of the display panel 10 to emit light toward the front in which the display panel 10 is located. According to an embodiment, the backlight unit may be provided as a surface light source. The display panel 10 may block or pass light emitted from the backlight unit based on the image data.

The backlight unit may include a point light source configured to emit monochromatic light or white light. In order to convert light, which is emitted from the point light source, into uniform surface light, the backlight unit may refract, reflect, and scatter light. The backlight unit may refract, reflect, and scatter light emitted from the point light source, thereby emitting uniform surface light toward the front side.

The backlight unit may include a light source module 100. The light source module 100 may include a plurality of light sources 110 configured to emit light and a light source board 120.

Each of the plurality of light sources 110 may be provided to emit monochromatic light or white light. Each of the plurality of light sources 110 may be configured as a point light source and configured to emit light in various directions. For example, the light source 110 may include a light emitting diode (LED).

A plurality of light sources 110 may be mounted on the light source board 120. The plurality of light sources 110 may be arranged on the light source board 120. The plurality of light sources 110 may be mounted on one surface of the light source board 120 that faces a light guide plate 20 to be described below. The light source board 120 may include circuit patterns for transmitting driving current and signals to the light sources 110. For example, the light source board 120 may include a printed circuit board (PCB) on which conductive circuit patterns are printed on one surface of the light source board 120 that faces the light guide plate 20 to be described below.

According to an embodiment, the light source board 120 may extend in one direction. According to an embodiment, the one direction may be linear or may not be linear. The light source board 120 may extend along one edge of the light guide plate 20 to be described below (e.g., a lower edge of the light guide plate 20). The plurality of light sources 110 may be arranged in a row along the extension direction of the light source board 120, on the light source board 120. The plurality of light sources 110 may be arranged spaced apart from each other along the extension direction of the light source board 120, on the light source board 120.

According to an embodiment, the display apparatus 1 may include a light guide plate 20. The light guide plate 20 may be configured to guide light emitted from the plurality of light sources 110 to the display panel 10. The light guide plate 20 may be configured to convert light emitted from the plurality of light sources 110 into surface light and guide the surface light to the display panel 10. Various patterns for changing the path of light may be formed on the light guide plate 20.

The light guide plate 20 may be disposed at the rear of the display panel 10. The light guide plate 20 may guide light emitted from the plurality of light sources 110 forward.

For example, the light guide plate 20 may include a poly methyl methacrylate acrylate (PMMA) material.

According to an embodiment, the light guide plate 20 may be formed in an approximately rectangular parallelepiped shape. The light guide plate 20 may have a front surface 21, a rear surface 22, and peripheral surfaces 23, 24, 25, and 26. The peripheral surfaces 23, 24, 25, and 26 may include an upper peripheral surface 23, a lower peripheral surface 24, a left peripheral surface 26, and a right peripheral surface 25. The upper peripheral surface 23 and lower peripheral surface 24 may each extend in the horizontal direction Y and may face each other in the vertical direction Z. The left peripheral surface 26 and right peripheral surface 25 may each extend in the vertical direction Z and may face each other in the horizontal direction Y. Each of the peripheral surfaces 23, 24, 25, and 26 may have a thickness approximately in the front-rear direction X.

The plurality of light sources 110 may be disposed adjacent to at least one peripheral surface among the peripheral surfaces 23, 24, 25, and 26 of the light guide plate 20. The plurality of light sources 110 may emit light toward at least one peripheral surface among the peripheral surfaces 23, 24, 25, and 26 of the light guide plate 20. Light emitted from the plurality of light sources 110 may be incident on the light guide plate 20 through at least one peripheral surface among the peripheral surfaces 23, 24, 25, and 26 of the light guide plate 20, and may be emitted from the light guide plate 20 through the front surface 21 of the light guide plate 20. Light emitted through the front surface 21 of the light guide plate 20 may be guided to the display panel 10. The surface through which light is incident among the peripheral surfaces 23, 24, 25, and 26 of the light guide plate 20 may be referred to as an incident surface of the light guide plate 20, and the front surface 21 of the light guide plate 20 may be referred to as an exit surface of the light guide plate 20.

For example, the plurality of light sources 110 may emit light toward the lower peripheral surface 24 among the peripheral surfaces 23, 24, 25, and 26 of the light guide plate 20. For this, the plurality of light sources 110 may be disposed adjacent to the lower peripheral surface 24 of the light guide plate 20. The light source board 120 may extend in the horizontal direction Y to be parallel to the lower peripheral surface 24 of the light guide plate 20. The plurality of light sources 110 may be arranged along the horizontal direction Y to be parallel to the lower peripheral surface 24.

However, the arrangement of the plurality of light sources 110 and the light source board 120 is not limited thereto, and in various embodiments, the plurality of light sources 110 may be disposed adjacent to at least one of the peripheral surfaces 23, 24, 25, and 26 of the light guide plate 20 and configured to emit light toward the peripheral surface, the light source board 120 may extend parallel to the peripheral surface, and the plurality of light sources 110 may be arranged along the extension direction.

The plurality of light sources 110 and the light guide plate 20 may be spaced apart from each other. When a gap between the light sources 110 and the light guide plate 20 varies, the luminance provided through the display panel 10 may change. Therefore, it is desirable that the distance between the light sources 110 and the light guide plate 20 be kept constant so that the luminance provided through the display panel 10 may be maintained uniformly.

According to an embodiment, the display apparatus 1 may include a rib 40 configured to maintain a spacing distance between the light guide plate 20 and the plurality of light sources 110. The rib 40 may be configured to maintain the spacing distance between one peripheral surface (e.g., a lower peripheral surface 24) that faces the plurality of light sources 110 among the peripheral surfaces 23, 24, 25, and 26 of the light guide plate 20 and the plurality of light sources 110. The rib 40 may also be referred to as a “spacer”.

The rib 40 may be disposed between the light guide plate 20 and the light source board 120. The rib 40 may be disposed between one peripheral surface (e.g., the lower peripheral surface 24) that faces the plurality of light sources 110 among the peripheral surfaces 23, 24, 25, and 26 of the light guide plate 20 and the light source board 120. The rib 40 may be disposed between some of the plurality of light sources 110. The rib 40 may be provided in plurality, and the plurality of ribs 40 may be disposed between the light guide plate 20 and the light source board 120 while being positioned between some of the plurality of light sources 110. The number of ribs 40 may be less than the number of light sources 110, and therefore the plurality of ribs 40 may not be disposed between each of the plurality of light sources 110 but may only be disposed between some of the plurality of light sources 110. The plurality of ribs 40 may be arranged to be spaced apart along an extension direction of the light source board 120.

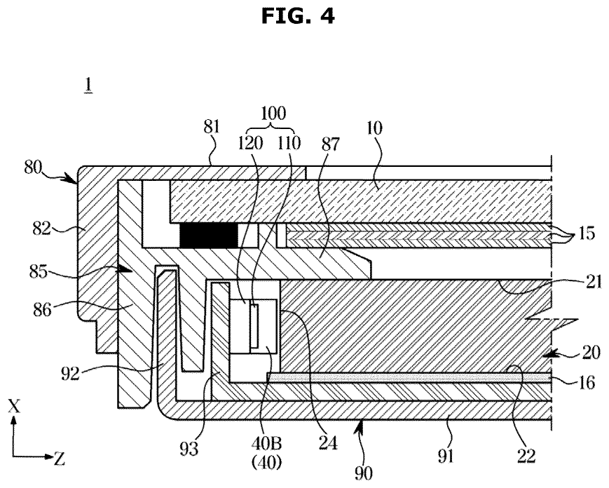

The rib 40 may be disposed at various positions to maintain the spacing distance between the light guide plate 20 and the plurality of light sources 110. According to an embodiment, as shown in FIG. 3, the rib 40 may include a rib 40A supported by a case (e.g., a middle mold 85) to be described below. For example, the rib 40A may extend from the middle mold 85 toward a space between the plurality of light sources 110 and the light guide plate 20. As an example, the rib 40A may be coupled to and supported by an intermediate support portion 87 of the middle mold 85 to be described below. According to an embodiment, as an example, the rib 40A may be formed integrally with the intermediate support portion 87 of the middle mold 85, but the disclosure is not limited thereto. For example, according to an embodiment, as shown in FIG. 4, the rib 40 may include a rib 40B. The rib 40B may be coupled to one side of the light source board 120 that faces the light guide plate 20.

As shown in FIGS. 2 and 3, the backlight unit may include a reflective sheet 16 configured to reflect light. The reflective sheet 16 may reflect light forward or in a direction approximate to forward. For example, the reflective sheet 16 may be disposed on a rear side of the light guide plate 20 to cause light emitted rearward from the light sources 110 to enter the light guide plate 20 or to cause light exiting rearward from the light guide plate 20 to re-enter the light guide plate 20.

As shown in FIGS. 2 and 3, the backlight unit may include various optical sheets 15 for improving the characteristics of emitted light.

For example, the optical sheets 15 may be configured to refract and/or scatter light to further improve the luminance or uniformity of luminance of light. For example, the optical sheets 15 may include various types of optical sheets such as a diffusion sheet, a prism sheets, and the like. The diffusion sheet may scatter light to offset the effects of patterns on the light guide plate 20. The prism sheet may concentrate light scattered by the diffusion sheet to improve luminance.

For example, the optical sheets 15 may include a quantum dot sheet for improving color reproducibility by changing the wavelength of light. Inside the quantum dot sheet, quantum dots, which are semiconductor crystals of several nanometer size that emit light, may be distributed. Quantum dots may receive blue light and generate light of various wavelengths according to their size, that is, all colors of visible light.

According to an embodiment, the plurality of light sources 110 may include light-emitting elements configured to emit blue light and a light-transmitting cover that covers the light-emitting elements. For example, the light-transmitting cover may include transparent silicon and may transmit blue light emitted from the light-emitting elements without changing the wavelength. For example, the light-transmitting cover may not be provided with separate light-converting phosphors. Thus, the plurality of light sources 110 may emit blue monochromatic light. The optical sheets 15 may include the quantum dot sheet to convert blue light emitted from the light sources 110 into white light and provide white light to the display panel 10.

However, the disclosure is not limited thereto, and according to an embodiment, phosphors (e.g., yellow phosphors) configured to convert the wavelength of light may be provided in the light-transmitting cover of the plurality of light sources 110, and the phosphors may convert blue light emitted from the light-emitting elements into white light. In such an embodiment, even when the optical sheets 15 do not include a quantum dot sheet, white light may be provided to the display panel 10 as white light is emitted from each of the plurality of light sources 110.

According to an embodiment, the display apparatus 1 may include one or more circuit board assemblies. For example, the display apparatus 1 may include a control board 50 configured to control the operation of the plurality of light sources 110 and the display panel 10, and a power supply board 60 configured to supply power to the light source module 100 and the display panel 10.

For example, the control board 50 may include a circuit board on which a memory, a processor and the like are mounted. For example, the power supply board 60 may include a circuit board on which a capacitor, a coil, a resistor element, a processor, and the like are mounted.

The control board 50 may include a control circuit for controlling the operation of the plurality of light sources 110 and the display panel 10. The control circuit may process image data received from an external content sources, transmit image data signals to the display panel 10, and transmit dimming data signals to the plurality of light sources 110.

The control board 50 may be connected to the light source board 120. The control board 50 may be connected to the light source board 120 through cables, and the like, and may control the plurality of light sources 110. The control board 50 may be configured to supply driving current to the plurality of light sources 110. The control board 50 may control on/off operations of each of the plurality of light sources 110.

In FIG. 2, in which the control board 50 and the power supply board 60 are illustrated as being configured as separate circuit board assemblies. However, the control board 50 and the power supply board 60 may be configured as a single integrated board assembly.

The display apparatus 1 may include a case configured to support various components of the display apparatus 1. Various components of the display apparatus 1 may be accommodated inside the case. The case may form the exterior of the display apparatus 1.

For example, the case may support the display panel 10. For example, the case may support the backlight unit, including the light source module 100, the reflective sheet 16, the optical sheets 15, and the like. For example, the case may support the control board 50. For example, the case may support the power supply board 60.

The case of the display apparatus 1 may include a front chassis 80. The front chassis 80 may support a front surface and/or side surfaces of the display panel 10. For example, the front chassis 80 may be arranged in approximately a rectangular frame shape. For example, the front chassis 80 may include a bezel 81 that covers the front surface of the display panel 10 and a rear extension portion 82 extending rearward from the bezel 81.

The case of the display apparatus 1 may include a middle mold 85. The middle mold 85 may be disposed between the front chassis 80 and the rear chassis 90. The middle mold 85 may be coupled to the rear side of the front chassis 80. For example, the middle mold 85 may support at least some components of the backlight unit. For example, the middle mold 85 may include a side portion 86 arranged in a rectangular frame shape and an intermediate support portion 87 protruding from the side portion 86 to support the light guide plate 20 and the optical sheets 15.

The case of the display apparatus 1 may include a rear chassis 90. The rear chassis 90 may cover the rear of the backlight unit including the light guide plate 20 and the light source module 100. The rear chassis 90 may be coupled to a rear side of the middle mold 85. The rear chassis 90 may support various components of the display apparatus 1 such as the backlight unit, the control board 50, the power supply board 60, and the like. For example, the rear chassis 90 may include a base 91 disposed at the rear of the light guide plate 20 and covering the light guide plate 20, and a front extension portion 92 extending forward from the edge of the base 91 and coupled to the middle mold 85.

The rear chassis 90 may be configured to include a material with high thermal conductivity to dissipate heat generated from the light source module 100 to the outside. For example, the rear chassis 90 may be configured to include a metal material such as aluminum or stainless steel (SUS), or plastic materials such as acrylonitrile butadiene styrene (ABS).

The case of the display apparatus 1 may include a board frame 93 configured to support the light source module 100. The light source board 120 may be coupled to and supported by the board frame 93. For example, the light source board 120 may be coupled to a portion of the board frame 93 that faces one peripheral surface (e.g., a lower peripheral surface 24) of the light guide plate 20. The board frame 93 may be coupled to and supported by the rear chassis 90. For example, the board frame 93 may include a material with high thermal conductivity, such as aluminum, and may be configured to receive heat generated from the light source module 100 and transfer the heat to the rear chassis 90. For example, the reflective sheet 16 may be supported by the board frame 93. According to an embodiment, the board frame 93 may be separate from the rear chassis 90, but the disclosure is not limited thereto. For example, according to an embodiment, the board frame 93 may be integrally formed with at least part of the rear chassis 90.

The case of the display apparatus 1 may include a rear cover 95. The rear cover 95 is disposed at the rear of the rear chassis 90 and may cover the rear chassis 90 and various components mounted at the rear of the rear chassis 90 (e.g., the control board 50, the power supply board 60, and the like). The rear cover 95 may form the rear exterior of the display apparatus 1. For example, the above-described support legs 2 may be coupled to the rear cover 95.

However, unlike the description above, in various embodiments, the case of the display apparatus 1 may not include some of the above described components among the front chassis 80, the middle mold 85, the rear chassis 90, the board frame 93, and the rear cover 95. Alternatively, one or more of the above described components among the front chassis 80, the middle mold 85, the rear chassis 90, the board frame 93, and the rear cover 95 may be combined into one component.

The configuration of the display apparatus 1 described above with reference to FIGS. 2 and 3 is merely an example for describing a display apparatus 1 according to an embodiment of the present disclosure, and the present disclosure is not limited thereto. In various embodiments of the present disclosure, the display apparatus may be configured to include various configurations for performing a function of providing images through a screen.

FIG. 4 is a cross-sectional view illustrating some components of a display apparatus according to an embodiment of the present disclosure.

Referring to FIG. 4, the display apparatus 1 according to an embodiment of the present disclosure may include a rib 40 configured to maintain a spacing distance between the light guide plate 20 and the plurality of light sources 110. The rib 40 may be configured to maintain a spacing distance between one peripheral surface (e.g., a lower peripheral surface 24) that faces the plurality of light sources 110 among the peripheral surfaces 23, 24, 25, and 26 of the light guide plate 20 and the plurality of light sources 110. The rib 40 may include a rib 40B supported by the light source board 120.

The rib 40B may be disposed between the light guide plate 20 and the light source board 120. The rib 40B may be disposed between one peripheral surface (e.g., a lower peripheral surface 24) that faces the plurality of light sources 110 among the peripheral surfaces 23, 24, 25, and 26 of the light guide plate 20 and the light source board 120. The rib 40B may be coupled to one side of the light source board 120 that faces the light guide plate 20.

The rib 40B may be disposed between some of the plurality of light sources 110. The rib 40B may be provided in plurality, and the plurality of ribs 40B may be disposed between the light guide plate 20 and the light source board 120 while being positioned between some of the plurality of light sources 110. The number of ribs 40B may be less than the number of light sources 110, and therefore the plurality of ribs 40B may not be disposed between each of the plurality of light sources 110 but may only be disposed between some of the plurality of light sources 110.

In FIG. 3, an embodiment in which the spacing distance between the light guide plate 20 and the plurality of light sources 110 is maintained by ribs 40A coupled to the middle mold 85 is illustrated, and in FIG. 4, an embodiment in which the spacing distance between the light guide plate 20 and the plurality of light sources 110 is maintained by the ribs 40B mounted on the light source board 120 is illustrated. In various embodiments, some of the plurality of ribs 40 included in the display apparatus 1 may be ribs 40A according to the embodiment of FIG. 3, and other some of the plurality of ribs 40 may be the ribs 40B according to the embodiment of FIG. 4. In various embodiments, each of the plurality of ribs 40 included in the display apparatus 1 may be the ribs 40A according to the embodiment of FIG. 3. In various embodiments, each of the plurality of ribs 40 included in the display apparatus 1 may be the ribs 40B according to the embodiment of FIG. 4.

In addition to this, the display apparatus 1 may include various ribs configured to maintain a spacing distance between the plurality of light sources 110 and the light guide plate 20.

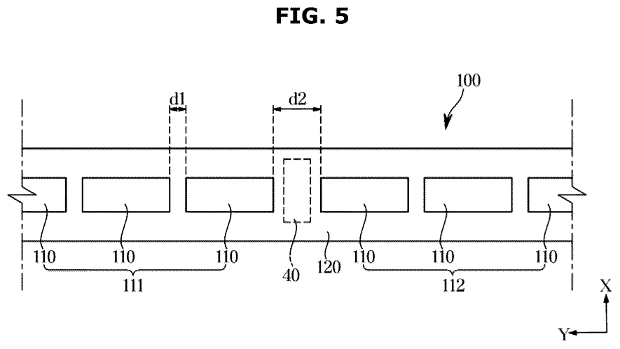

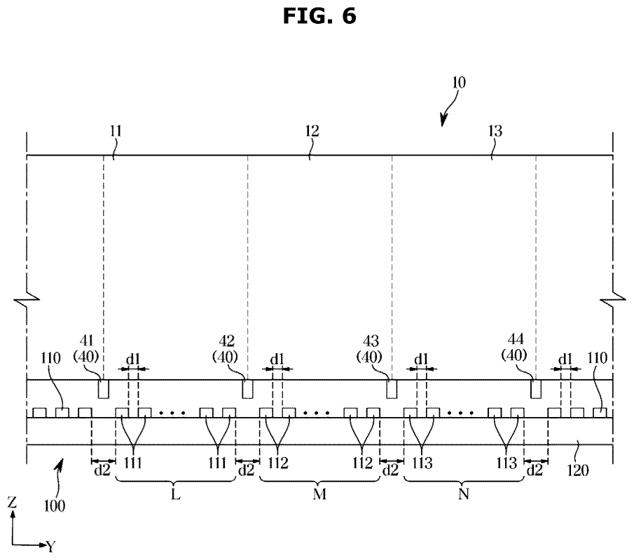

FIG. 5 is an enlarged view illustrating a part of a light source module of a display apparatus according to an embodiment of the present disclosure. FIG. 6 is an enlarged view illustrating a light source module of a display apparatus, and parts of a screen and ribs corresponding thereto according to an embodiment of the present disclosure.

Referring to FIGS. 5 and 6, in the display apparatus 1 according to an embodiment of the present disclosure, the plurality of light sources 110 may be arranged in one direction. For example, the plurality of light sources 110 may be arranged along an extension direction of the light source board 120. A plurality of ribs 40 may be disposed between some of the plurality of light sources 110 arranged in the one direction.

The plurality of light sources 110 may include a plurality of light source groups divided by the plurality of ribs 40. Each of the plurality of ribs 40 may be disposed between the plurality of light source groups. The light sources 110 included in each of the plurality of light source groups may be disposed between a pair of adjacent ribs 40 among the plurality of ribs 40.

The plurality of light sources 110 may include various numbers of light source groups, and the number of light source groups may vary depending on the number and arrangement of ribs 40. Hereinafter, referring to FIGS. 5 and 6, an embodiment in which the plurality of light sources 110 include at least three or more light source groups (a first light source group 111, a second light source group 112, and a third light source group 113) will be described, but various embodiments of the present disclosure are not limited thereto.

The number of light sources 110 included in each of the plurality of light source groups may vary depending on the number and arrangement of ribs 40. Hereinafter, referring to FIGS. 5 and 6, an embodiment in which the first light source group 111 includes a first number L of light sources 110, the second light source group 112 includes a second number M of light sources 110, and the third light source group 113 includes a third number N of light sources 110 will be described, but in various embodiments, the number of light sources 110 included in each light source group is not limited thereto.

The plurality of light sources 110 may include a first light source group 111 disposed between a first rib 41 and a second rib 42 that are adjacent to each other among the plurality of ribs 40. The first light source group 111 may include light sources 110 disposed between the first rib 41 and the second rib 42. Hereinafter, the light sources 110 included in the first light source group 111 are referred to as first light sources. The first light source group 111 may include a first number L of first light sources.

The first light sources included in the first light source group 111 may be arranged spaced apart from each other in one direction between the first rib 41 and the second rib 42. For example, the first light sources may be spaced apart from each other by a first interval d1. For example, the first light sources included in the first light source group 111 may be spaced apart from each other by the same first interval d1. However, depending on the embodiment, even when the first light sources are generally spaced apart by substantially the same first interval d1, some of the first light sources may be spaced apart at an interval different from the intervals between other first light sources in consideration of avoiding interference with circuit elements, such as IC chips, circuit lines, and other structures inside the display apparatus 1 mounted on the light source board 120.

The plurality of light sources 110 may include a second light source group 112 disposed between a second rib 42 and a third rib 43 that are adjacent to each other among the plurality of ribs 40. The second light source group 112 may include light sources 110 disposed between the second rib 42 and the third rib 43. Hereinafter, the light sources 110 included in the second light source group 112 are referred to as second light sources. The second light source group 112 may include a second number M of second light sources.

For example, the first rib 41 may be disposed at one side of the second rib 42, and the third rib 43 may be disposed at the other side of the second rib 42 opposite to the first rib 41. The first rib 41 may be the closest rib 40 disposed at one side of the second rib 42, and the third rib 43 may be the closest rib 40 disposed at the other side of the second rib 42. The second rib 42 may be disposed between the first rib 41 and the third rib 43. The first rib 41, the second rib 42, and the third rib 43 may be arranged in order along the direction in which the plurality of light sources 110 are arranged.

The second light sources included in the second light source group 112 may be arranged spaced apart from each other in one direction between the second rib 42 and the third rib 43. For example, the second light sources may be spaced apart from each other by a first interval d1. For example, the second light sources included in the second light source group 112 may be spaced apart from each other by the same first interval d1. However, depending on the embodiment, even when the second light sources are generally spaced apart by substantially the same first interval d1, some of the second light sources may be spaced apart at an interval different from the intervals between other second light sources in consideration of avoiding interference with circuit elements, such as IC chips, circuit lines, and other structures inside the display apparatus 1 mounted on the light source board 120.

The plurality of light sources 110 may include a third light source group 113 disposed between a third rib 43 and a fourth rib 44 that are adjacent to each other among the plurality of ribs 40. The third light source group 113 may include light sources 110 disposed between the third rib 43 and the fourth rib 44. Hereinafter, the light sources 110 included in the third light source group 113 are referred to as third light sources. The third light source group 113 may include a third number N of third light sources.

For example, the second rib 42 may be disposed at one side of the third rib 43, and the fourth rib 44 may be disposed at the other side of the third rib 43 opposite to the second rib 42. The second rib 42 may be the closest rib 40 disposed at one side of the third rib 43, and the fourth rib 44 may be the closest rib 40 disposed on the other side of the third rib 43. The third rib 43 may be disposed between the second rib 42 and the fourth rib 44. The first rib 41, the second rib 42, the third rib 43, and the fourth rib 44 may be arranged in order along the direction in which the plurality of light sources 110 are arranged.

The third light sources included in the third light source group 113 may be arranged spaced apart from each other in one direction between the third rib 43 and the fourth rib 44. For example, the third light sources may be spaced apart from each other by a first interval d1. For example, the third light sources included in the third light source group 113 may be spaced apart from each other by the same first interval d1. However, depending on the embodiment, even when the third light sources are generally spaced apart by substantially the same first interval d1, some of the third light sources may be spaced apart at an interval different from the intervals between other third light sources in consideration of avoiding interference with circuit elements, such as IC chips, circuit lines, and other structures inside the display apparatus 1 mounted on the light source board 120.

The direction in which the first light source group 111, the second light source group 112, and the third light source group 113 are arranged may be the same as the direction in which the plurality of light sources 110 are arranged and the direction in which the plurality of ribs 40 (e.g., the first rib 41, the second rib 42, the third rib 43, and the fourth rib 44) are arranged. For example, the plurality of light sources 110 may be arranged in the horizontal direction Y, the plurality of ribs 40 may be arranged in the same horizontal direction Y, and the first light source group 111, the second light source group 112, and the third light source group 113 may be arranged in the same horizontal direction Y.

The screen of the display panel 10 may be divided into a plurality of areas to correspond to the plurality of light source groups. The display panel 10 may include a plurality of areas corresponding to the plurality of light source groups. The plurality of areas may be arranged along the direction in which the plurality of light source groups are arranged.

For example, the display panel 10 may include a first area 11 corresponding to the first light source group 111. The first area 11 may correspond to the first light sources included in the first light source group 111. Light emitted from the first light sources may pass through the light guide plate 20 and be provided at a high rate to the first area 11 of the display panel 10. A high proportion of the light provided to the first area 11 of the display panel 10 may be light emitted from the first light sources. For example, the first area 11 may be located approximately in front of a partial area of the light guide plate 20 that faces the first light sources.

For example, the display panel 10 may include a second area 12 corresponding to the second light source group 112. The second area 12 may correspond to the second light sources included in the second light source group 112. Light emitted from the second light sources may pass through the light guide plate 20 and be provided at a high rate to the second area 12 of the display panel 10. A high proportion of the light provided to the second area 12 of the display panel 10 may be light emitted from the second light sources. For example, the second area 12 may be located approximately in front of a partial area of the light guide plate 20 that faces the second light sources.

For example, the display panel 10 may include a third area 13 corresponding to the third light source group 113. The third area 13 may correspond to the third light sources included in the third light source group 113. Light emitted from the third light sources may pass through the light guide plate 20 and be provided at a high rate to the third area 13 of the display panel 10. A high proportion of the light provided to the third area 13 of the display panel 10 may be light emitted from the third light sources. For example, the third area 13 may be located approximately in front of a partial area of the light guide plate 20 that faces the third light sources.

The first area 11, the second area 12, and the third area 13 may be arranged in the direction in which the first light source group 111, the second light source group 112, and the third light source group 113 are arranged. The first area 11, the second area 12, and the third area 13 may be arranged in the direction in which the first rib 41, the second rib 42, the third rib 43, and the fourth rib 44 are arranged. The second area 12 may be disposed between the first area 11 and the third area 13. For example, the plurality of light sources 110 may be arranged in the horizontal direction Y, the first light source group 111, the second light source group 112, and the third light source group 113 may be arranged in the horizontal direction Y, and the first area 11, the second area 12, and the third area 13 of the display panel 10 may be arranged in the same horizontal direction Y.

For uniformity of luminance provided through the display panel 10, the plurality of light sources 110 may be arranged spaced apart at a generally uniform first interval d1. However, in areas in which ribs 40 are located, light sources 110 may not be disposed. Therefore, as shown in FIG. 5, a pair of light sources 110 disposed on both sides of a rib 40 and closest to the rib 40 may be spaced apart from each other by a second interval d2 larger than the first interval d1. A light source group (e.g., a first light source group 111) located at one side of a rib 40 and a light source group (e.g., a second light source group 112) located at the other side of the rib 40 may be spaced apart from each other by a second interval d2 that is larger than the first interval d1 at which the light sources 110 included in each light source group are spaced apart from each other.

For example, the first light source group 111 and the second light source group 112 may be spaced apart from each other by a second interval d2. Among the first light sources included in the first light source group 111, a first light source closest to the second rib 42, and among the second light sources included in the second light source group 112, a second light source closest to the second rib 42 may be spaced apart from each other by a second interval d2.

For example, the second light source group 112 and the third light source group 113 may be spaced apart from each other by a second interval d2. Among the second light sources included in the second light source group 112, a second light source closest to the third rib 43, and among the third light sources included in the third light source group 113, a third light source closest to the third rib 43 may be spaced apart from each other by a second interval d2.

As each of the plurality of light sources 110 emits light in various directions, the luminance on the screen of the display panel 10 needs to have relatively high uniformity. However, as described above, since the second interval d2 between the light source groups 111, 112, and 113 is larger than the first interval d1 between the light sources 110 included in each of the light source groups 111, 112, and 113, the luminance may become discontinuous at boundaries between the respective areas 11, 12, and 13 of the display panel 10.

Furthermore, ribs 40 (e.g., the second rib 42 and the third rib 43) may be disposed between the light source groups 111, 112, and 113, and the ribs 40 may block part of the light emitted from the light sources 110. For example, the ribs 40 may obstruct light traveling in an oblique direction with respect to the vertical direction Z, thereby preventing light emitted from each light source group 111, 112, and 113 from being provided to other areas 11, 12, and 13 than the areas corresponding thereto among the areas 11, 12, 13 of the display panel 10.

For example, light emitted from the first light sources included in the first light source group 111 may be provided to the second area 12 at a relatively low rate due to a relatively long distance to the second light source group 112 or interference caused by the second rib 42. Similarly, light emitted from the second light sources included in the second light source group 112 may be provided to the first area 11 at a relatively low rate due to a relatively long distance to the first light source group 111 or interference caused by the second rib 42. Accordingly, in an embodiment, when there is a difference between the amount of light emitted from the first light source group 111 and the amount of light emitted from the second light source group 112, a luminance difference may occur between the first area 11 and the second area 12. The same applies to the relationship between the second light source group 112 and the third light source group 113, and the relationship between the second area 12 and the third area 13.

According to various embodiments, the number of light sources 110 included in each of the light source groups 111, 112, and 113 may be different from each other. Thus, when currents of the same magnitude are supplied to the light source groups 111, 112, and 113, a difference may occur in the amounts of light emitted from the light source groups 111, 112, and 113.

For example, the first light source group 111 may include a first number L of first light sources, and the second light source group 112 may include a second number M of second light sources that is greater than the first number L. When currents of the same magnitude are supplied to the first light sources included in the first light source group 111 and the second light sources included in the second light source group 112, the amount of light emitted from the first light source group 111 may become smaller than the amount of light emitted from the second light source group 112, and the luminance of the first area 11 may become lower than the luminance of the second area 12. When the luminance difference between the first area 11 and the second area 12 is sufficiently large, the first area 11 may be perceived as a relatively dark area by a viewer.

Therefore, in order to reduce the luminance difference between the first area 11 and the second area 12 and reduce and/or prevent the first area 11 from being perceived as a dark area, at least some of the first light sources of the first light source group 111 disposed between the first rib 41 and the second rib 42 may be supplied with a first magnitude of current, and at least some of the second light sources of the second light source group 112 disposed between the second rib 42 and the third rib 43 may be supplied with a second magnitude of current smaller than the first magnitude. The control board 50 may supply a first magnitude of current to at least some of the first light sources of the first light source group 111 disposed between the first rib 41 and the second rib 42, and supply a second magnitude of current smaller than the first magnitude to at least some of the second light sources of the second light source group 112 disposed between the second rib 42 and the third rib 43.

The difference between the first magnitude of current and the second magnitude of current may be determined based on the difference between the luminance of light emitted from the first area 11 and the luminance of light emitted from the second area 12. For example, the difference between the first magnitude of current and the second magnitude of current may be determined experimentally and empirically in various manners.

Thus, a difference between the amount of light emitted from the first light source group 111 and the amount of light emitted from the second light source group 112 may be reduced, and a luminance difference between the first area 11 and the second area 12 may be reduced, thereby reducing and/or preventing the first area 11 from being perceived as a dark area.

According to an embodiment, the current supplied to each of the plurality of light sources 110 may vary based on a driving signal generated by the control board 50. That is, not only the currents supplied to different light sources 110, but also the current supplied to a single light source 110 may continuously vary based on the driving signal generated by the control board 50. In such an embodiment, supplying the first magnitude of current to at least some of the first light sources of the first light source group 111 may represent that the maximum current that may be supplied to the corresponding light sources is the first magnitude, and supplying the second magnitude of current smaller than the first magnitude to at least some of the second light sources of the second light source group 112 may represent that the maximum current that may be supplied to the corresponding light sources is the second magnitude smaller than the first magnitude. However, embodiments of the present disclosure are not limited thereto, and in various embodiments, supplying the first magnitude of current to at least some of the first light sources of the first light source group 111 may represent that the average current supplied to the corresponding light sources is the first magnitude, and supplying the second magnitude of current smaller than the first magnitude to at least some of the second light sources of the second light source group 112 may represent that the average current supplied to the corresponding light sources is the second magnitude smaller than the first magnitude.

According to an embodiment, the third light source group 113 may include a third number N of third light sources that is greater than the first number L and smaller than the second number M.

When currents of the same magnitude are supplied to the second light sources of the second light source group 112 and the third light sources of the third light source group 113, a difference in the amount of light emitted from the second light source group 112 and the amount of light emitted from the third light source group 113 may occur due to the difference between the second number M and the third number N, and a difference in the luminance of the second area 12 and the luminance of the third area 13 may occur. In such a case, when the difference between the second number M and the third number N is greater than or equal to a certain number, the difference in luminance between the second area 12 and the third area 13 due to the difference between the second number M and the third number N may become sufficiently large such that the third area 13 may be perceived as a dark area by a viewer. Conversely, when the difference between the second number M and the third number N is smaller than the certain number, the difference in luminance between the second area 12 and the third area 13 due to the difference between the second number M and the third number N may not be sufficiently large such that the third area 13 may not be perceived as a dark area by a viewer.

Therefore, according to an embodiment, when the difference between the second number M and the third number N is greater than or equal to the certain number, the first magnitude of current may be supplied to at least some of the third light sources of the third light source group 113. According to an embodiment, when the difference between the second number M and the third number Nis smaller than the certain number, the second magnitude of current may be supplied to at least some of the third light sources of the third light source group 113.

According to an embodiment, the third light source group 113 may include a third number N of third light sources that is greater than the first number L and smaller than the second number M, and a third magnitude of current that is smaller than the first magnitude and greater than the second magnitude may be supplied to at least some of the third light sources of the third light source group 113.

According to an embodiment, the third light source group 113 may include a third number N of third light sources that is greater than the second number M. According to an embodiment, when the difference between the second number M and the third number Nis greater than or equal to a certain number, a third magnitude of current smaller than the second magnitude may be supplied to at least some of the third light sources of the third light source group 113. According to an embodiment, when the difference between the second number M and the third number N is smaller than the certain number, the second magnitude of current may be supplied to at least some of the third light sources of the third light source group 113.

By adjusting the current supplied to the light sources 110 as described above, the uniformity of luminance of the display panel 10 may be improved, and the occurrence of dark areas being visually perceived may be reduced and/or prevented.

According to an embodiment, the same magnitude of current may be supplied to light sources 110 included in the same light source group among the light source groups 111, 112, and 113. For example, the same first magnitude of current may be supplied to each of the first light sources included in the first light source group 111. For example, the same second magnitude (smaller than the first magnitude) of current may be supplied to each of the second light sources included in the second light source group 112.

However, embodiments of the present disclosure are not limited thereto, and the magnitude of current supplied to each light source 110 may be variously provided as long as it can reduce dark areas from being visually perceived due to luminance differences. For example, among the first number L of first light sources included in the first light source group 111, at least some first light sources adjacent to the second light source group 112 (e.g., some first light sources adjacent to the second rib 42) may be supplied with the first magnitude of current, and among the second number M (L<M) of second light sources included in the second light source group 112, at least some second light sources adjacent to the first light source group 111 (e.g., some second light sources adjacent to the second rib 42) may be supplied with the second magnitude of current smaller than the first magnitude.

Hereinafter, various examples will be described in which currents are supplied to light sources 110 included in adjacent light source groups with reference to the first light source group 111 and the second light source group 112 to improve a luminance uniformity.

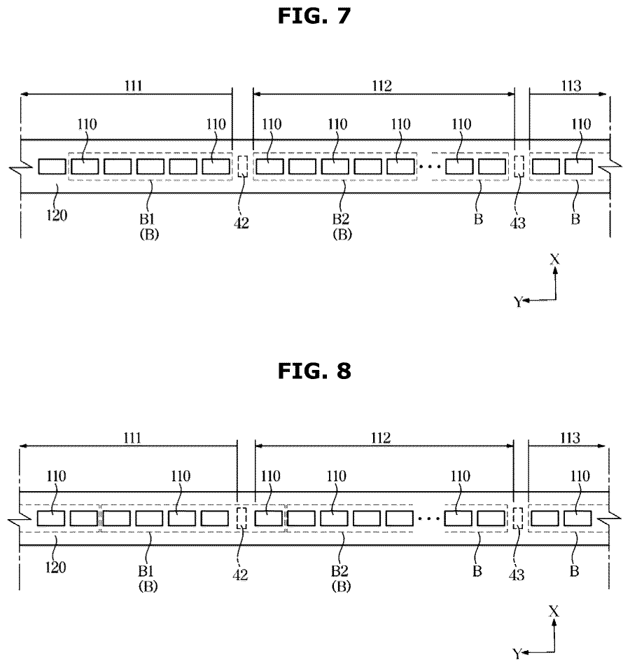

FIG. 7 is a diagram illustrating some light source groups and dimming blocks included in a light source module of a display apparatus according to an embodiment of the present disclosure.

Referring to FIG. 7, the plurality of light sources 110 included in the display apparatus 1 according to an embodiment of the present disclosure may form (e.g., include) a plurality of dimming blocks B each including a predetermined number of light sources 110. The plurality of light sources 110 may be divided into a plurality of dimming blocks B.

In FIG. 7, each dimming block B is illustrated as including five light sources 110, but embodiments of the present disclosure are not limited thereto, and each dimming block B may include various numbers of light sources 110. According to an embodiment, each of the plurality of dimming blocks B may include the same number of light sources 110, but the disclosure is not limited thereto, and some of the plurality of dimming blocks B may include different numbers of light sources 110.

The control board 50 may control a current supplied to each dimming block B according to the input image. The control board 50 may decrease a current supplied to a dimming block B corresponding to a dark area of the input image and increase a current supplied to a dimming block B corresponding to a bright area of the input image, thereby efficiently improving contrast ratio. For example, light sources 110 belonging to the same dimming block B may be supplied with the same driving current and may emit light of the same brightness. For example, according to dimming data, light sources 110 belonging to some of different dimming blocks B may be supplied with different driving currents and the light sources 110 belonging to some of different dimming blocks B may emit light of different brightness.

According to an embodiment, among the plurality of dimming blocks B, a first dimming block B1 may include some of the first light sources included in the first light source group 111 that are adjacent to the second light source group 112. The first dimming block B1 may include some of the first light sources included in the first light source group 111 that are adjacent to the second rib 42. Each of the light sources 110 included in the first dimming block B1 may be supplied with a first magnitude of current.

According to an embodiment, among the plurality of dimming blocks B, a second dimming block B2 may include some of the second light sources included in the second light source group 112 that are adjacent to the first light source group 111. The second dimming block B2 may include some of the second light sources included in the second light source group 112 that are adjacent to the second rib 42. Each of the light sources 110 included in the second dimming block B2 may be supplied with a second magnitude of current smaller than the first magnitude.

As shown in FIG. 7, according to an embodiment, the first dimming block B1 may include a first light source closest to the second rib 42 among the first light sources of the first light source group 111 disposed between the first rib 41 and the second rib 42. Including the first light source closest to the second rib 42 among the first light sources of the first light source group 111 disposed between the first rib 41 and the second rib 42, the entire first dimming block B1 may be supplied with the first magnitude of current.

As shown in FIG. 7, according to an embodiment, the second dimming block B2 may include a second light source closest to the second rib 42 among the second light sources of the second light source group 112 disposed between the second rib 42 and the third rib 43. Including the second light source closest to the second rib 42 among the second light sources of the second light source group 112 disposed between the second rib 42 and the third rib 43, the entire second dimming block B2 may be supplied with the second magnitude of current smaller than the first magnitude.

According to an embodiment, some dimming blocks B among the plurality of dimming blocks B may have all of the light sources 110 included therein disposed between the first rib 41 and the second rib 42. For example, the light sources 110 included in the first dimming block B1 may all be first light sources disposed between the first rib 41 and the second rib 42. A dimming blocks B including only first light sources may be supplied with the first magnitude of current.

According to an embodiment, some dimming blocks B among the plurality of dimming blocks B may have all of the light sources 110 included therein disposed between the second rib 42 and the third rib 43. For example, the light sources 110 included in the second dimming block B2 may all be second light sources disposed between the second rib 42 and the third rib 43. A dimming blocks B including only second light sources may be supplied with the second magnitude of current smaller than the first magnitude.

FIG. 8 is a diagram illustrating some light source groups and dimming blocks included in a light source module of a display apparatus according to an embodiment of the present disclosure.

Referring to FIG. 8, the plurality of light sources 110 included in the display apparatus 1 according to an embodiment of the present disclosure may form a plurality of dimming blocks B, each including a predetermined number of light sources 110.

According to an embodiment, among the plurality of dimming blocks B, a first dimming block B1 may include some of the first light sources of the first light source group 111 that are adjacent to the second light source group 112. The first dimming block B1 may include some of the first light sources of the first light source group 111 that are adjacent to the second rib 42.

As shown in FIG. 8, according to an embodiment, the first dimming block B1 may include a first light source closest to the second rib 42 among the first light sources of the first light source group 111 disposed between the first rib 41 and the second rib 42. According to an embodiment, the first dimming block B1 may also include some of the second light sources adjacent to the second rib 42 among the second light sources of the second light source group 112 disposed between the second rib 42 and the third rib 43. For example, among the light sources 110 included in the first dimming block B1, the number of first light sources may be greater than the number of second light sources, but embodiments of the present disclosure are not limited thereto. Each of the light sources 110 included in the first dimming block B1 (including first light sources included in the first light source group 111 and second light sources included in the second light source group 112) may be supplied with the first magnitude of current.

According to an embodiment, among the plurality of dimming blocks B, a second dimming block B2 may include some of the second light sources of the second light source group 112 that are adjacent to the first light source group 111. The second dimming block B2 may include some of the second light sources of the second light source group 112 that are adjacent to the second rib 42.

As shown in FIG. 8, according to an embodiment, the second dimming block B2 may include second light sources adjacent to the second rib 42 among the second light sources of the second light source group 112 disposed between the second rib 42 and the third rib 43, but may not include a second light source that is closest to the second rib 42. Each of the light sources 110 included in the second dimming block B2 may be supplied with the second magnitude of current smaller than the first magnitude.

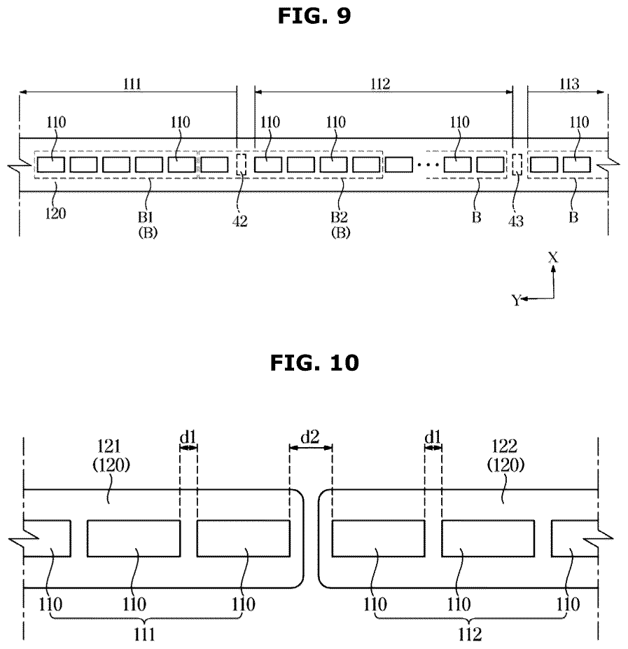

FIG. 9 is a diagram illustrating some light source groups and dimming blocks included in a light source module of a display apparatus according to an embodiment of the present disclosure.

Referring to FIG. 9, the plurality of light sources 110 included in the display apparatus 1 according to an embodiment of the present disclosure may form a plurality of dimming blocks B each including a predetermined number of light sources 110.

According to an embodiment, among the plurality of dimming blocks B, a first dimming block B1 may include some of the first light sources of the first light source group 111 that are adjacent to the second light source group 112. The first dimming block B1 may include some of the first light sources of the first light source group 111 that are adjacent to the second rib 42.

As shown in FIG. 9, according to an embodiment, the first dimming block B1 may include first light sources adjacent to the second rib 42 among the first light sources of the first light source group 111 disposed between the first rib 41 and the second rib 42, but may not include a first light source that is the closest to the second rib 42. Each of the light sources 110 included in the first dimming block B1 may be supplied with the first magnitude of current.

According to an embodiment, among the plurality of dimming blocks B, a second dimming block B2 may include some of the second light sources of the second light source group 112 that are adjacent to the first light source group 111. The second dimming block B2 may include some of the second light sources of the second light source group 112 that are adjacent to the second rib 42.

As shown in FIG. 9, according to an embodiment, the second dimming block B2 may include a second light source closest to the second rib 42 among the second light sources of the second light source group 112 disposed between the second rib 42 and the third rib 43. According to an embodiment, the second dimming block B2 may also include some of the first light sources adjacent to the second rib 42 among the first light sources of the first light source group 111 disposed between the first rib 41 and the second rib 42. For example, among the light sources 110 included in the second dimming block B2, the number of second light sources may be greater than the number of first light sources, but embodiments of the present disclosure are not limited thereto. Each of the light sources 110 included in the second dimming block B2 (including first light sources included in the first light source group 111 and second light sources included in the second light source group 112) may be supplied with the second magnitude of current smaller than the first magnitude.

As described with reference to FIGS. 7, 8, and 9 along with FIGS. 5 and 6, in various embodiments, the uniformity of luminance of the display panel 10 may be improved by adjusting the current supplied to each of the light sources 110 based on the number of light sources 110 disposed between a pair of adjacent ribs 40.

According to various embodiments, the dimming blocks B in the plurality of light sources 110 may be formed in the same manner as anyone of the embodiments illustrated in FIG. 7, FIG. 8, or FIG. 9. According to various embodiments, the dimming blocks B in the plurality of light sources 110 may be formed in a combined manner of two or more of the embodiments of FIG. 7, FIG. 8, or FIG. 9.

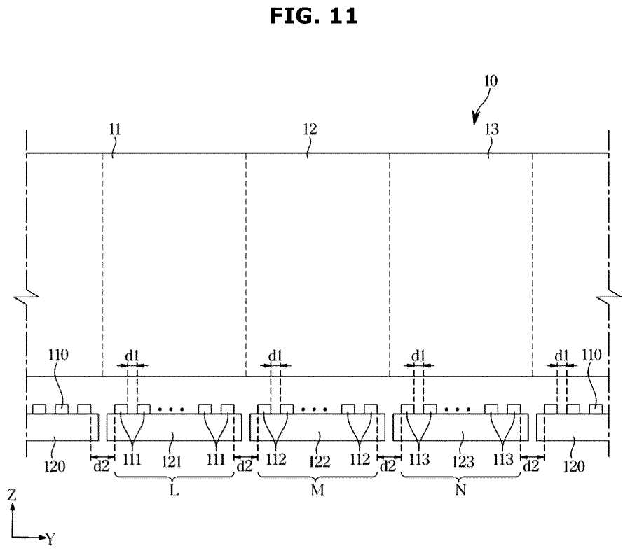

FIG. 10 is an enlarged view illustrating a part of a light source module of a display apparatus according to an embodiment of the present disclosure. FIG. 11 is an enlarged view illustrating a light source module of a display apparatus, and part of a screen corresponding thereto according to an embodiment of the present disclosure.

In describing an embodiment of the present disclosure with reference to FIGS. 10 and 11, the same reference numerals are assigned to the same configurations as those in the embodiments described above with reference to FIGS. 1 to 9, and detailed description thereof may be omitted.

Referring to FIGS. 10 and 11, the display apparatus 1 according to an embodiment of the present disclosure may include a plurality of light source boards 120. The plurality of light source boards 120 may be arranged side by side along one peripheral surface of the light guide plate 20. For example, the plurality of light source boards 120 may be arranged in the horizontal direction Y parallel to the lower peripheral surface 24 of the light guide plate 20. The plurality of light source boards 120 may be arranged spaced apart from each other.

The plurality of light sources 110 may include a plurality of light source groups to correspond to the plurality of light source boards 120. For example, one light source group may correspond to one light source board 120. For example, light sources 110 included in one light source group may be mounted on one light source board 120.

The plurality of light sources 110 may include various numbers of light source groups, and the number of light source groups may vary depending on the number, length, and arrangement of light source boards 120. Hereinafter, referring to FIGS. 10 and 11, an embodiment in which the light source board 120 includes at least three or more light source boards (a first light source board 121, a second light source board 122, and a third light source board 123), and the plurality of light sources 110 include at least three or more light source groups (a first light source group 111, a second light source group 112, and a third light source group 113) will be described, but various embodiments of the present disclosure are not limited thereto.

The plurality of light sources 110 may include a first light source group 111 including a first number L of first light sources mounted on the first light source board 121. The first light sources included in the first light source group 111 may be arranged spaced apart from each other in one direction on the first light source board 121. For example, the first light sources may be spaced apart from each other by a first interval d1. For example, the first light sources included in the first light source group 111 may be spaced apart from each other by the same first interval d1. However, depending on the embodiment, even when the first light sources are generally spaced apart by substantially the same first interval d1, some of the first light sources may be spaced apart at an interval different from the intervals between other first light sources in consideration of avoiding interference with circuit elements, such as IC chips, circuit lines, and other structures inside the display apparatus 1 mounted on the light source board 120.

The plurality of light sources 110 may include a second light source group 112 including a second number M of second light sources mounted on the second light source board 122. The second light sources included in the second light source group 112 may be arranged spaced apart from each other in one direction on the second light source board 122. For example, the second light sources may be spaced apart from each other by a first interval d1. For example, the second light sources included in the second light source group 112 may be spaced apart from each other by the same first interval d1. However, depending on the embodiment, even when the second light sources are generally spaced apart by substantially the same first interval d1, some of the second light sources may be spaced apart at an interval different from the intervals between other second light sources in consideration of avoiding interference with circuit elements, such as IC chips, circuit lines, and other structures inside the display apparatus 1 mounted on the light source board 120.

The plurality of light sources 110 may include a third light source group 113 including a third number N of third light sources mounted on the third light source board 123. The third light sources included in the third light source group 113 may be arranged spaced apart from each other in one direction on the third light source board 123. For example, the third light sources may be spaced apart from each other by a first interval d1. For example, the third light sources included in the third light source group 113 may be spaced apart from each other by the same first interval d1. However, depending on the embodiment, even when the third light sources are generally spaced apart by substantially the same first interval d1, some of the third light sources may be spaced apart at an interval different from the intervals between other third light sources in consideration of avoiding interference with circuit elements, such as IC chips, circuit lines, and other structures inside the display apparatus 1 mounted on the light source board 120.

The first light source board 121, the second light source board 122, and the third light source board 123 may be arranged in order along the direction in which the plurality of light sources 110 are arranged (e.g., the horizontal direction Y). For example, the second light source board 122 may be disposed between the first light source board 121 and the third light source board 123. The arrangement direction and order of the first light source board 121, the second light source board 122, and the third light source board 123 may be the same as the arrangement direction and order of the first light source group 111, the second light source group 112, and the third light source group 113.

The screen of the display panel 10 may be divided into a plurality of areas to correspond to the plurality of light source groups. The display panel 10 may include a plurality of areas corresponding to the plurality of light source groups. The plurality of areas may be arranged along the direction in which the plurality of light source groups are arranged.

For example, the display panel 10 may include a first area 11 corresponding to the first light source group 111. The first area 11 may correspond to the first light sources mounted on the first light source board 121. Light emitted from the first light sources mounted on the first light source board 121 may pass through the light guide plate 20 and be provided at a high rate to the first area 11 of the display panel 10. A high proportion of the light provided to the first area 11 of the display panel 10 may be light emitted from the first light sources. For example, the first area 11 may be located approximately in front of a partial area of the light guide plate 20 that faces the first light sources.

For example, the display panel 10 may include a second area 12 corresponding to the second light source group 112. The second area 12 may correspond to the second light sources mounted on the second light source board 122. Light emitted from the second light sources mounted on the second light source board 122 may pass through the light guide plate 20 and be provided at a high rate to the second area 12 of the display panel 10. A high proportion of the light provided to the second area 12 of the display panel 10 may be light emitted from the second light sources. For example, the second area 12 may be located approximately in front of a partial area of the light guide plate 20 that faces the second light sources.

For example, the display panel 10 may include a third area 13 corresponding to the third light source group 113. The third area 13 may correspond to the third light sources mounted on the third light source board 123. Light emitted from the third light sources mounted on the third light source board 123 may pass through the light guide plate 20 and be provided at a high rate to the third area 13 of the display panel 10. A high proportion of the light provided to the third area 13 of the display panel 10 may be light emitted from the third light sources. For example, the third area 13 may be located approximately in front of a partial area of the light guide plate 20 that faces the third light sources.

The first area 11, the second area 12, and the third area 13 may be arranged in the direction in which the first light source group 111, the second light source group 112, and the third light source group 113 are arranged. The first area 11, the second area 12, and the third area 13 may be arranged in the direction in which the first light source board 121, the second light source board 122, and the third light source board 123 are arranged. The second area 12 may be disposed between the first area 11 and the third area 13.

The first light sources of the first light source group 111 mounted on the first light source board 121 may be arranged spaced apart by approximately the first interval d1. The second light sources of the second light source group 112 mounted on the second light source board 122 may be arranged spaced apart by approximately the first interval d1. The third light sources of the third light source group 113 mounted on the third light source board 123 may be arranged spaced apart by approximately the first interval d1.

The first light source board 121 and the second light source board 122 may be spaced apart from each other. Accordingly, among the first light sources of the first light source group 111 disposed on the first light source board 121, a first light source closest to the second light source board 122, and among the second light sources of the second light source group 112 disposed on the second light source board 122, a second light source closest to the first light source board 121 may be spaced apart from each other by a second interval d2 larger than the first interval d1.

The second light source board 122 and the third light source board 123 may be spaced apart from each other. Accordingly, among the second light sources of the second light source group 112 disposed on the second light source board 122, a second light source closest to the third light source board 123, and among the third light sources of the third light source group 113 disposed on the third light source board 123, a third light source closest to the second light source board 122 may be spaced apart from each other by a second interval d2 larger than the first interval d1.

As each of the plurality of light sources 110 emits light in various directions, the luminance on the screen of the display panel 10 needs to have relatively high uniformity. However, as described above, since the second interval d2 between the light source groups 111, 112, and 113 is larger than the first interval d1 between the light sources 110 included in each of the light source groups 111, 112, and 113, the luminance may become discontinuous at the boundaries between each of the areas 11, 12, and 13 of the display panel 10.

According to various embodiments, the number of light sources 110 included in each of the light source groups 111, 112, and 113 may be different from each other. Thus, when currents of the same magnitude are supplied to the light source groups 111, 112, and 113, a difference may occur in the amounts of light emitted from the light source groups 111, 112, and 113.

For example, a first number L of first light sources may be mounted on the first light source board 121, and a second number M of second light sources greater than the first number L may be mounted on the second light source board 122. When currents of the same magnitude are supplied to the first light sources mounted on the first light source board 121 and the second light sources mounted on the second light source board 122, the amount of light emitted from the first light source group 111 may become smaller than the amount of light emitted from the second light source group 112, and the luminance of the first area 11 may become lower than the luminance of the second area 12. When the luminance difference between the first area 11 and the second area 12 is sufficiently large, the first area 11 may be perceived as a relatively dark area by a viewer.

Therefore, in order to reduce the luminance difference between the first area 11 and the second area 12 and reduce and/or prevent the first area 11 from being perceived as a dark area, at least some of the first light sources of the first light source group 111 mounted on the first light source board 121 may be supplied with a first magnitude of current, and at least some of the second light sources of the second light source group 112 mounted on the second light source board 122 may be supplied with a second magnitude of current smaller than the first magnitude. The control board 50 may supply a first magnitude of current to at least some of the first light sources of the first light source group 111 mounted on the first light source board 121, and supply a second magnitude of current smaller than the first magnitude to at least some of the second light sources of the second light source group 112 mounted on the second light source board 122.

According to an embodiment, at least some of the first light sources adjacent to the second light source board 122 among the first light sources of the first light source group 111 mounted on the first light source board 121 may be supplied with a first magnitude of current, and for example, the at least some first light sources may include a first light source closest to the second light source board 122 among the first light sources of the first light source group 111. According to an embodiment, at least some of the second light sources adjacent to the first light source board 121 among the second light sources of the second light source group 112 mounted on the second light source board 122 may be supplied with a second magnitude of current smaller than the first magnitude, and for example, the at least some second light sources may include a second light source closest to the first light source board 121 among the second light sources of the second light source group 112.

The difference between the first magnitude of current and the second magnitude of current may be determined based on the difference between the luminance of light emitted from the first area 11 and the luminance of light emitted from the second area 12. For example, the difference between the first magnitude of current and the second magnitude of current may be determined experimentally and empirically in various manners.

According to an embodiment, a third number N of third light sources that is greater than the first number L and smaller than the second number M may be mounted on the third light source board 123. According to an embodiment, when the difference between the second number M and the third number N is greater than or equal to a certain number, the first magnitude of current may be supplied to at least some of the third light sources mounted on the third light source board 123. According to an embodiment, when the difference between the second number M and the third number N is smaller than the certain number, the second magnitude of current may be supplied to at least some of the third light sources mounted on the third light source board 123.

According to an embodiment, a third number N of third light sources that is greater than the first number L and smaller than the second number M may be mounted on the third light source board 123, and a third magnitude of current that is smaller than the first magnitude and greater than the second magnitude may be supplied to at least some of the third light sources mounted on the third light source board 123.

According to an embodiment, a third number N of third light sources greater than the second number M may be included on the third light source board 123. According to an embodiment, when the difference between the second number M and the third number Nis greater than or equal to a certain number, a third magnitude of current smaller than the second magnitude may be supplied to at least some of the third light sources mounted on the third light source board 123. According to an embodiment, when the difference between the second number M and the third number N is smaller than the certain number, a second magnitude of current may be supplied to at least some of the third light sources mounted on the third light source board 123.

By adjusting the current supplied to the light sources 110 as described above, the uniformity of luminance of the display panel 10 may be improved, and the occurrence of dark areas being visually perceived may be reduced and/or prevented.

According to an embodiment, the same magnitude of current may be supplied to light sources 110 mounted on the same light source board among the plurality of light source boards 121, 122, and 123. However, embodiments of the present disclosure are not limited thereto, and the magnitude of current supplied to each light source 110 may be variously provided as long as it can reduce the perception of dark areas due to luminance differences.

In the description above with reference to FIGS. 10 and 11, an embodiment in which the plurality of light sources 100 are divided into different light source groups as the plurality of light source boards 120 are spaced apart from each other has been described. In various embodiments, as described with reference to FIGS. 5 to 9, the plurality of light sources 100 may be divided into different light source groups by the plurality of ribs 40, or as described with reference to FIGS. 10 and 11, the plurality of light sources 100 may be divided into different light source groups by the plurality of light source boards 120, or the plurality of light sources 100 may be divided into different light source groups by both the plurality of ribs 40 and the plurality of light source boards 120.

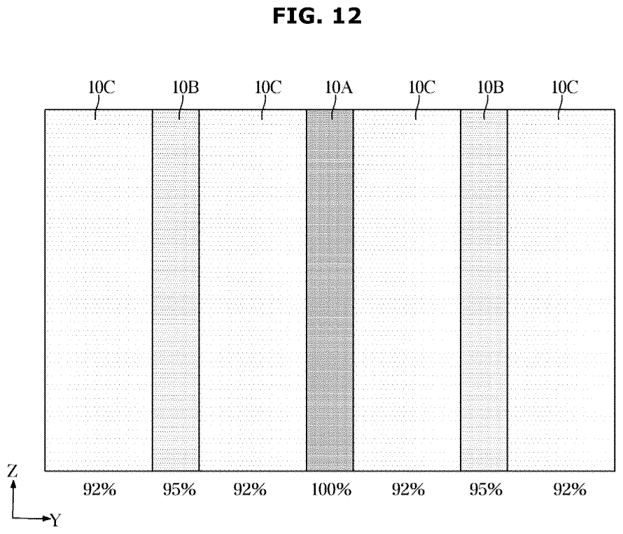

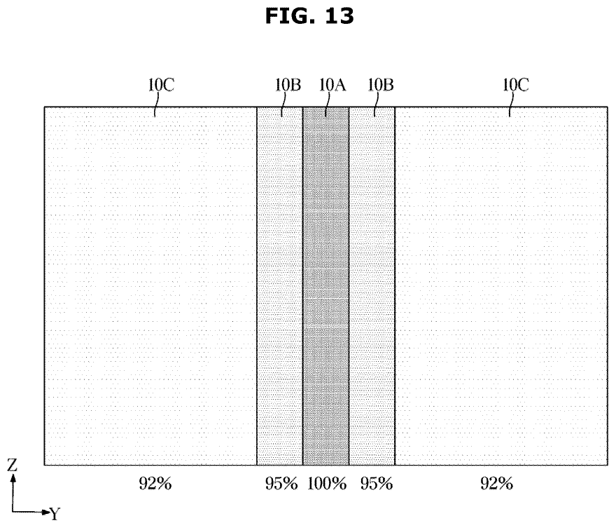

FIG. 12 is a diagram illustrating areas on a screen of a display apparatus and maximum current supplied to corresponding light sources according to an embodiment of the present disclosure. FIG. 13 is a diagram illustrating areas on a screen of a display apparatus and maximum current supplied to corresponding light sources according to an embodiment of the present disclosure.

In FIGS. 12 and 13, various examples of the magnitudes of currents supplied to light sources 110 according to the number of light sources 110 included in each of the plurality of light source groups are illustrated.

Referring to FIGS. 12 and 13, according to an embodiment of the present disclosure, the differences in the currents supplied to the light sources 110 may be determined based on the luminance of light emitted on the screen of the display panel 10.

According to an embodiment, the plurality of light sources 100 may include a plurality of light source groups distinguished from each other as described with reference to FIGS. 5 to 11, and the number of light sources 110 included in a light source group may be different between the plurality of light source groups.

For example, as illustrated in FIGS. 12 and 13, an area 10A may correspond to a light source group including a first number of light sources 110 (hereinafter referred to as a “first light source group”), an area 10B may correspond to a light source group including a second number of light sources 110 greater than the first number (hereinafter referred to as a “second light source group”), and an area 10C may correspond to a light source group including a third number of light sources 110 greater than the second number (hereinafter referred to as a “third light source group”).

When the same magnitude of current is supplied to each of the first light source group, the second light source group, and the third light source group, the amount of light from the first light source group may be the smallest and the amount of light from the third light source group may be the largest. Therefore, the luminance of the area 10A may be the lowest, and the luminance of the area 10C may be the highest.

In order to reduce the luminance difference between the areas 10A, 10B, and 10C, the control board 50 may supply the largest current to the first light source group, supply a current smaller than the current supplied to the first light source group to the second light source group, and supply a current smaller than the current supplied to the second light source group to the third light source group.

In FIGS. 12 and 13, an example in which, when the magnitude of current supplied to the first light source group is 100%, a current magnitude of 95% is supplied to the second light source group, and a current magnitude of 92% is supplied to the third light source group is illustrated, but the ratio of the magnitudes of the currents is not limited thereto.

By supplying different currents to the light sources 110 as described above, uniformity of luminance on the screen may be improved and the perception of dark areas may be reduced and/or prevented.

A display apparatus according to an embodiment of the disclosure may include a display panel, a light guide plate disposed at a rear of the display panel, a plurality of light sources disposed adjacent to a peripheral surface of the light guide plate and configured to emit light toward the peripheral surface of the light guide plate, a light source board on which the plurality of light sources are arranged, a plurality of ribs disposed between the light guide plate and the light source board to maintain a spacing distance between the light guide plate and the plurality of light sources, the plurality of ribs being disposed between some light sources among the plurality of light sources, and a control board connected to the light source board and configured to supply a driving current to the plurality of light sources. A first number of first light sources among the plurality of light sources may be disposed between a first rib and a second rib that are adjacent to each other among the plurality of ribs. A second number of second light sources greater than the first number may be disposed between the second rib and a third rib adjacent to the second rib among the plurality of ribs. The control board may be configured to supply a first magnitude of current to at least some of the first light sources disposed between the first rib and the second rib, and supply a second magnitude of current smaller than the first magnitude to at least some of the second light sources disposed between the second rib and the third rib.

The control board may be configured to supply the first magnitude of current to a light source, among the first light sources disposed between the first rib and the second rib, that is closest to the second rib.

The control board may be configured to supply the second magnitude of current to a light source, among the second light sources disposed between the second rib and the third rib, that is closest to the second rib.

The plurality of light sources may be configured to form a plurality of dimming blocks each including a predetermined number of light sources. Among the plurality of dimming blocks, some dimming blocks may have all of the light sources included therein disposed between the first rib and the second rib. The control board may be configured to supply the first magnitude of current to each of the light sources included in the some dimming blocks.

The plurality of light sources may be configured to form a plurality of dimming blocks each including a predetermined number of light sources. Among the plurality of dimming blocks, a single dimming block may include a light source among the first light sources disposed between the first rib and the second rib that is closest to the second rib. The control board may be configured to supply the first magnitude of current to each of the light sources included in the single dimming block.

The single dimming block may include some light sources, among the second light sources disposed between the second rib and the third rib, adjacent to the second rib.

The plurality of light sources may be configured to form a plurality of dimming blocks each including a predetermined number of light sources. Among the plurality of dimming blocks, some dimming blocks may have all of the light sources included therein disposed between the second rib and the third rib, and the control board may be configured to supply the second magnitude of current to each of the light sources included in the some dimming blocks.

The plurality of light sources may be configured to form a plurality of dimming blocks each including a predetermined number of light sources. Among the plurality of dimming blocks, a single dimming block may include a light source among the second light sources disposed between the second rib and the third rib that is closest to the second rib. The control board may be configured to supply the second magnitude of current to each of the light sources included in the single dimming block.

The single dimming block may include some light sources, among the first light sources disposed between the first rib and the second rib, adjacent to the second rib.

The first light sources disposed between the first rib and the second rib may be arranged spaced apart from each other by a first interval. The second light sources disposed between the second rib and the third rib may be arranged spaced apart from each other by the first interval. A light source, among the first light sources disposed between the first rib and the second rib, closest to the second rib and a light source, among the second light sources disposed between the second rib and the third rib, closest to the second rib may be spaced apart from each other by a second interval larger than the first interval.

A third number of third light sources greater than the first number and smaller than the second number may be disposed between the third rib and a fourth rib adjacent to the third rib among the plurality of ribs. The control board may be configured to supply the second magnitude of current to at least some of the third light sources disposed between the third rib and the fourth rib.

A third number of third light sources greater than the second number may be disposed between the third rib and a fourth rib adjacent to the third rib among the plurality of ribs. The control board may be configured to supply a third magnitude of current smaller than the second magnitude to at least some of the third light sources disposed between the third rib and the fourth rib.

The first magnitude of current may be a maximum current supplied to the at least some of the first light sources. The second magnitude of current may be a maximum current supplied to the at least some of the second light sources.

The second rib may be disposed between the first rib and the third rib. The first rib, the second rib, and the third rib may be sequentially arranged along one direction in which the plurality of light sources are arranged.

The display panel may include a first area corresponding to the first light sources disposed between the first rib and the second rib among the plurality of light sources, and a second area corresponding to the second light sources disposed between the second rib and the third rib. A difference between the first magnitude of current and the second magnitude of current may be determined based on a difference between luminance of light emitted from the first area and luminance of light emitted from the second area.

A display apparatus according to an embodiment of the present disclosure may include a display panel, a light guide plate disposed at a rear of the display panel, a plurality of light sources disposed adjacent to a peripheral surface of the light guide plate and configured to emit light toward the peripheral surface of the light guide plate, and a control board configured to supply a driving current to the plurality of light sources. The plurality of light sources may include a first light source group including a first number of first light sources arranged spaced apart from each other by a first interval, and a second light source group including a second number of second light sources, which is greater than the first number, arranged spaced apart from each other by the first interval, the second light source group being spaced apart from the first light source group by a second interval greater than the first interval. The control board may be configured to supply a first magnitude of current to at least some of the first light sources included in the first light source group, and supply a second magnitude of current, which is smaller than the first magnitude, to at least some of the second light sources included in the second light source group.

The display apparatus may further include a light source board on which the plurality of light sources are arranged, and a plurality of ribs disposed between the light guide plate and the light source board to maintain a spacing distance between the light guide plate and the plurality of light sources. The first light source group may be disposed between a first rib and a second rib that are adjacent to each other among the plurality of ribs. The second light source group may be disposed between the second rib and a third rib adjacent to the second rib among the plurality of ribs.

The display apparatus may further include a first light source board on which the first light sources included in the first light source group are mounted, and a second light source board on which the second light sources included in the second light source group are mounted. The first light source board and the second light source board may be spaced apart from each other.

The plurality of light sources may be configured to form a plurality of dimming blocks, each including a predetermined number of light sources. Among the plurality of dimming blocks, a first dimming block may include some first light sources, among the first light sources, adjacent to the second light source group. Among the plurality of dimming blocks, a second dimming block may include some second light sources, among the second light sources, adjacent to the first light source group. The control board may be configured to supply the first magnitude of current to each of the light sources included in the first dimming block, and supply the second magnitude of current to each of the light sources included in the second dimming block.

A display apparatus according to an embodiment of the present disclosure may include a display panel, a light guide plate disposed at a rear of the display panel, a plurality of light sources disposed adjacent to a peripheral surface of the light guide plate and configured to emit light toward the peripheral surface of the light guide plate, a first light source board on which a first number of light sources among the plurality of light sources are mounted, a second light source board adjacent to the first light source board, on which a second number of light sources, which is greater than the first number, among the plurality of light sources are mounted, and a control board connected to the first light source board and the second light source board and configured to supply a driving current to the plurality of light sources. The control board may be configured to supply a first magnitude of current to at least some of the light sources mounted on the first light source board, and supply a second magnitude of current to at least some of the light sources mounted on the second light source board.

According to the spirit of the present disclosure, the display apparatus may, even upon occurrence of a region in which the amount of light is relatively restricted due to a structure of the backlight unit, supply a smaller current to light sources corresponding to an adjacent region than to light sources corresponding to the region, thereby dark areas can be reduced and/or prevented from being perceived on the screen.

According to the spirit of the present disclosure, by reducing and/or preventing visibility of dark areas on the screen, luminance uniformity on the screen can be improved.

The effects of the disclosure are not limited to the effects described above, and other effects that are not described will be clearly understood by those skilled in the art from the above detailed description.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A display apparatus comprising:
a display panel;
a light guide plate at a rear of the display panel;
a light source board;
a plurality of light sources on the light source board and adjacent to a peripheral surface of the light guide plate, the plurality of light sources being configured to emit light toward the peripheral surface of the light guide plate;
a plurality of ribs between the light guide plate and the light source board and between light sources among the plurality of light sources; and
a control board connected to the light source board and configured to supply a driving current to the plurality of light sources,
wherein the plurality of light sources comprises a first number of first light sources, and a second number of second light sources that is greater than the first number,
wherein the first light sources are between a first rib and a second rib that is adjacent to the first rib among the plurality of ribs,
wherein the second light sources are between the second rib and a third rib that is adjacent to the second rib among the plurality of ribs, and
wherein the control board is configured to:
supply a first current of a first magnitude to at least some of the first light sources, and
supply a second current of a second magnitude less than the first magnitude to at least some of the second light sources.

2. The display apparatus of claim 1, wherein the control board is further configured to supply the first current to a light source, among the first light sources, closest to the second rib.

3. The display apparatus of claim 1, wherein the control board is further configured to supply the second current to a light source, among the second light sources, closest to the second rib.

4. The display apparatus of claim 1, further comprising a plurality of dimming blocks, each of the plurality of dimming blocks comprising a predetermined number of light sources among the plurality of light sources,
wherein all light sources comprised in one or more dimming blocks among the plurality of dimming blocks are the first light sources, and
wherein the control board is further configured to supply the first current to each light source included in the one or more dimming blocks.

5. The display apparatus of claim 1, further comprising a plurality of dimming blocks, each of the plurality of dimming blocks comprising a predetermined number of light sources among the plurality of light sources,
wherein, among the plurality of dimming blocks, a first dimming block comprises a light source that is closest to the second rib among the first light sources, and
wherein the control board is further configured to supply the first current to each light source included in the first dimming block.

6. The display apparatus of claim 5, wherein the first dimming block further comprises one or more light sources, among the second light sources, adjacent to the second rib.

7. The display apparatus of claim 1, further comprising a plurality of dimming blocks, each of the plurality of dimming blocks comprising a predetermined number of light sources among the plurality of light sources,
wherein all light sources comprised in one or more dimming blocks among the plurality of dimming blocks are the second light sources, and
wherein the control board is further configured to supply the second current to each light source included in the one or more dimming blocks.

8. The display apparatus of claim 1, further comprising a plurality of dimming blocks, each of the plurality of dimming blocks comprising a predetermined number of light sources among the plurality of light sources,
wherein, among the plurality of dimming blocks, a first dimming block comprises a light source that is closest to the second rib among the second light sources, and
wherein the control board is further configured to supply the second current to each light source included in the first dimming block.

9. The display apparatus of claim 8, wherein the first dimming block further comprises one or more light sources, among the first light sources, adjacent to the second rib.

10. The display apparatus of claim 1, wherein the first light sources are arranged to be spaced apart from each other by a first interval,
wherein the second light sources are arranged to be spaced apart from each other by the first interval, and
wherein one of the first light sources that is closest to the second rib and one of the second light sources that is closest to the second rib are spaced apart from each other by a second interval that is larger than the first interval.

11. The display apparatus of claim 1, wherein the plurality of light sources further comprises a third number of third light sources, the third number being greater than the first number and less than the second number,
wherein the third light sources are between the third rib and a fourth rib that is adjacent to the third rib among the plurality of ribs, and
wherein the control board is further configured to supply the second current to at least some of the third light sources.

12. The display apparatus of claim 1, wherein the plurality of light sources further comprises a third number of third light sources, the third number being greater than the second number,
wherein the third light sources are between the third rib and a fourth rib that is adjacent to the third rib among the plurality of ribs, and
wherein the control board is further configured to supply a third current of a third magnitude less than the second magnitude to at least some of the third light sources.

13. The display apparatus of claim 1, wherein the first current is a maximum current supplied to the at least some of the first light sources, and
wherein the second current is a maximum current supplied to the at least some of the second light sources.

14. The display apparatus of claim 1, wherein the second rib is between the first rib and the third rib, and
wherein the first rib, the second rib, and the third rib are sequentially arranged along a direction in which the plurality of light sources are arranged.

15. The display apparatus of claim 1, wherein the display panel comprises a first area corresponding to the first light sources, and a second area corresponding to the second light sources, and
wherein a difference between the first magnitude of the first current and the second magnitude of the second current is based on a difference between a luminance of light emitted from the first area and a luminance of light emitted from the second area.

16. A display apparatus comprising:
a display panel;
a light guide plate at a rear of the display panel;
a light source board;
a plurality of light sources on the light source board and adjacent to a peripheral surface of the light guide plate, the plurality of light sources being configured to emit light toward the peripheral surface of the light guide plate;
a plurality of ribs between the light guide plate and the light source board and between the plurality of light sources;
a plurality of dimming blocks, each of the plurality of dimming blocks comprising light sources among the plurality of light sources; and
a control board connected to the light source board and configured to supply a driving current to the plurality of light sources,
wherein the plurality of light sources comprises:
a first number of first light sources;
a second number of second light sources, the second number being greater than the first number, and
wherein plurality of dimming blocks comprises a first dimming block comprising at least some of the first light sources, and a second dimming block comprising at least some of the second light sources,
wherein the first light sources are between a first rib and a second rib that is adjacent to the first rib among the plurality of ribs,
wherein the second light sources are between the second rib and a third rib that is adjacent to the second rib among the plurality of ribs, and
wherein the control board is configured to:
supply a first current of a first magnitude to the first dimming block, and
supply a second current of a second magnitude less than the first magnitude to the second dimming block.

17. The display apparatus of claim 16, wherein all light sources comprised in the first dimming block among the plurality of dimming blocks are the first light sources.

18. The display apparatus of claim 16, wherein the first dimming block further comprises one or more light sources, among the second light sources, adjacent to the second rib.

19. The display apparatus of claim 16, wherein all light sources comprised in the second dimming block among the plurality of dimming blocks are the second light sources.

20. The display apparatus of claim 16, wherein the second dimming block further comprises one or more light sources, among the first light sources, adjacent to the second rib.
